(19) United States
(12) Patent Application Publication
(10) Pub. No.: US 2005/0050170 A1
(43) Pub. Date: Mar. 3, 2005

(54) Method and apparatus for securely conducting digital property trade

(75) Inventors: Jimmy Ming-Der Hsu, Austin, TX (US); Peter Y. Hsu, Austin, TX (US)

Correspondence Address: IBM CORP (YA);C/O YEE & ASSOCIATES PC, P.O. BOX 802333, DALLAS, TX, 75380, US

(73) Assignee: International Business Machines Corporation, Armonk, NY (US)

(21) Appl. No.: 10/651,716

(22) Filed: Aug. 29, 2003

(51) Int. Cl. G06F 15/16

(52) U.S. Cl. 709/219

(57) ABSTRACT

A method, apparatus, and computer instructions for transferring a unique digital item in a network data processing system. A request to transfer a unique digital item from a source account on a source data processing system to a target account on a target data processing system is received. The transfer request includes the unique digital item and an identification of the target account. A determination is made as to whether the request is valid in response to receiving the request. In response to the request being valid, a transfer of the unique digital item to the target account in the second data processing system is attempted. Responsive to a successful transfer of the unique digital item to the target account, the unique digital item is deleted from the source account in the source data processing system.

### CROSS REFERENCE TO RELATED APPLICATIONS

The present invention is related to the following applications entitled: “Method and Apparatus for Temporary Ownership of Digital Items in a Network Data Processing System,” Ser. No. ______, attorney docket no. AUS920030184US1 and “Method and Apparatus for Trading Digital Items in a Network Data Processing System,” serial no. ______, attorney docket no. AUS920030183US1; filed even date hereof, assigned to the same assignee, and incorporated herein by reference.

### BACKGROUND OF THE INVENTION

1. Technical Field

The present invention relates generally to an improved data processing system and in particular, to an improved method, apparatus, and computer instructions for transferring data. Still more particularly, the present invention provides an improved method, apparatus, and computer instructions for exchanging digital items.

2. Description of Related Art

The Internet, also referred to as an “internetwork”, is a set of computer networks, possibly dissimilar, joined together by means of gateways that handle data transfer and the conversion of messages from a protocol of the sending network to a protocol used by the receiving network. When capitalized, the term “Internet” refers to the collection of networks and gateways that use the TCP/IP suite of protocols.

The Internet has become a cultural fixture as a source of both information and entertainment. Many businesses are creating Internet sites as an integral part of their marketing efforts, informing consumers of the products or services offered by the business or providing other information seeking to engender brand loyalty. Many federal, state, and local government agencies are also employing Internet sites for informational purposes, particularly agencies which must interact with virtually all segments of society such as the Internal Revenue Service and secretaries of state. Providing informational guides and/or searchable databases of online public records may reduce operating costs. Further, the Internet is becoming increasingly popular as a medium for commercial transactions.

Currently, the most commonly employed method of transferring data over the Internet is to employ the World Wide Web environment, also called simply “the Web”. Other Internet resources exist for transferring information, such as File Transfer Protocol (FTP) and Gopher, but have not achieved the popularity of the Web. In the Web environment, servers and clients effect data transaction using the Hypertext Transfer Protocol (HTTP), a known protocol for handling the transfer of various data files (e.g., text, still graphic images, audio, motion video, etc.). The information in various data files is formatted for presentation to a user by a standard page description language, the Hypertext Markup Language (HTML). In addition to basic presentation formatting, HTML allows developers to specify “links” to other Web resources identified by a Uniform Resource Locator (URL). A URL is a special syntax identifier defining a communications path to specific information. Each logical block of information accessible to a client, called a “page” or a “Web page”, is identified by a URL. The URL provides a universal, consistent method for finding and accessing this information, not necessarily for the user, but mostly for the user's Web “browser”. A browser is a program capable of submitting a request for information identified by an identifier, such as, for example, a URL. A user may enter a domain name through a graphical user interface (GUI) for the browser to access a source of content. The domain name is automatically converted to the Internet Protocol (IP) address by a domain name system (DNS), which is a service that translates the symbolic name entered by the user into an IP address by looking up the domain name in a database.

While the Internet is commonly used to sell the types of goods typically offered in a so-called “brick and mortar” business, the Internet also is used to transfer digital goods, which may exist nowhere else. The Internet also is widely used to transfer applications to users using browsers. With respect to commerce on the Web, individual consumers and businesses use the Web to purchase various goods and services. In offering goods and services, some companies offer goods and services solely on the Web while others use the Web to extend their reach. Many items exist only on servers on the Web. In the digital world, money may be manifested as “e-money” or “digital cash”. With e-money, a digitally signed and encrypted block of data representing a money order on a bank is used. Another example of digital property is music, which may be purchased and possessed. The popularity of online gaming communities is a growing trend. In many of these gaming environments, digital items or properties may be traded between different players. For example, armors, rings, weapons, characters, and even castles may be traded between different players. Some of these items have even been auctioned on auctioning websites. All of these are examples of the rapid acceptance of digital property.

With many of these applications, interfaces are present for trading property within the same application. The present invention recognizes that a secure system for trading property between different applications and different users is absent. With the insecure mechanisms presently used, a multitude of scams and fraudulent transfers have occurred.

Therefore, it would be advantageous to have an improved method, apparatus, and computer instructions for exchanging digital items.

### SUMMARY OF THE INVENTION

The present invention provides a method, apparatus, and computer instructions for transferring a unique digital item in a network data processing system. A request to transfer a unique digital item from a source account on a source data processing system to a target account on a target data processing system is received. The transfer request includes the unique digital item and an identification of the target account. A determination is made as to whether the request is valid in response to receiving the request. In response to the request being valid, a transfer of the unique digital item to the target account in the second data processing system is attempted. Responsive to a successful transfer of the unique digital item to the target account, the unique digital item is deleted from the source account in the source data processing system.

### BRIEF DESCRIPTION OF THE DRAWINGS

The novel features believed characteristic of the invention are set forth in the appended claims. The invention itself, however, as well as a preferred mode of use, further objectives and advantages thereof, will best be understood by reference to the following detailed description of an illustrative embodiment when read in conjunction with the accompanying drawings, wherein:

FIG. 1 is a pictorial representation of a network of data processing systems in which the present invention may be implemented;

FIG. 2 is a block diagram of a data processing system that may be implemented as a server in accordance with a preferred embodiment of the present invention;

FIG. 3 is a block diagram illustrating a data processing system in which the present invention may be implemented;

FIGS. 4A-4D are diagrams illustrating components used in transferring unique digital items in accordance with a preferred embodiment of the present invention;

FIG. 5 is a flowchart of a process for transferring a unique digital item in accordance with a preferred embodiment of the present invention;

FIG. 6 is a flowchart of a process for managing a transfer of a unique digital item in accordance with a preferred embodiment of the present invention;

FIG. 7 is a flowchart of a process for a transfer of a unique digital item in accordance with a preferred embodiment of the present invention; and

FIG. 8 is a flowchart of a process for grouping items in accordance with a preferred embodiment of the prevention process.

### DETAILED DESCRIPTION OF THE PREFERRED EMBODIMENT

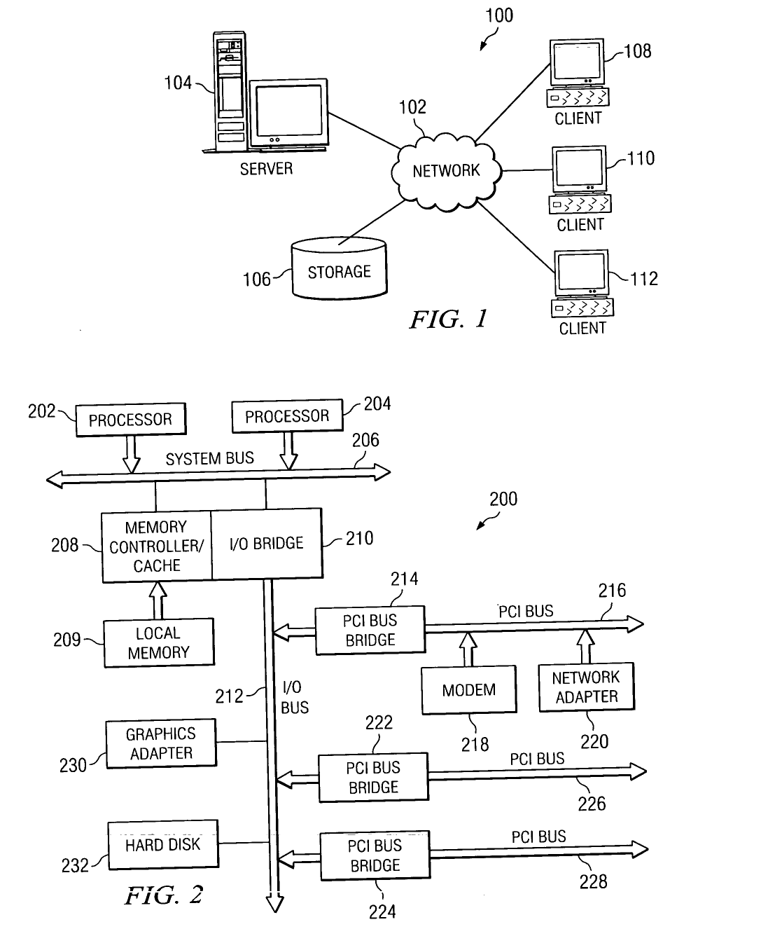

With reference now to the figures, FIG. 1 depicts a pictorial representation of a network of data processing systems in which the present invention may be implemented. Network data processing system 100 is a network of computers in which the present invention may be implemented. Network data processing system 100 contains a network 102, which is the medium used to provide communication links between various devices and computers connected together within network data processing system 100. Network 102 may include connections, such as wire, wireless communication links, or fiber optic cables.

In the depicted example, server 104 is connected to network 102 along with storage unit 106. In addition, clients 108, 110, and 112 are connected to network 102. Clients 108, 110, and 112 may be, for example, personal computers or network computers. In the depicted example, server 104 provides data, such as boot files, operating system images, and applications to clients 108-112. Clients 108, 110, and 112 are clients to server 104. Network data processing system 100 may include additional servers, clients, and other devices not shown.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, government, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the present invention.

Referring to FIG. 2, a block diagram of a data processing system that may be implemented as a server, such as server 104 in FIG. 1, is depicted in accordance with a preferred embodiment of the present invention. Data processing system 200 may be a symmetric multiprocessor (SMP) system including a plurality of processors 202 and 204 connected to system bus 206. Alternatively, a single processor system may be employed. Also connected to system bus 206 is memory controller/cache 208, which provides an interface to local memory 209. I/O bus bridge 210 is connected to system bus 206 and provides an interface to I/O bus 212. Memory controller/cache 208 and I/O bus bridge 210 may be integrated as depicted.

Peripheral component interconnect (PCI) bus bridge 214 connected to I/o bus 212 provides an interface to PCI local bus 216. A number of modems may be connected to PCI local bus 216. Typical PCI bus implementations will support four PCI expansion slots or add-in connectors. Communications links to clients 108-112 in FIG. 1 may be provided through modem 218 and network adapter 220 connected to PCI local bus 216 through add-in boards.

Additional PCI bus bridges 222 and 224 provide interfaces for additional PCI local buses 226 and 228, from which additional modems or network adapters may be supported. In this manner, data processing system 200 allows connections to multiple network computers. A memory-mapped graphics adapter 230 and hard disk 232 may also be connected to I/O bus 212 as depicted, either directly or indirectly.

Those of ordinary skill in the art will appreciate that the hardware depicted in FIG. 2 may vary. For example, other peripheral devices, such as optical disk drives and the like, also may be used in addition to or in place of the hardware depicted. The depicted example is not meant to imply architectural limitations with respect to the present invention.

The data processing system depicted in FIG. 2 may be, for example, an IBM eServer pSeries system, a product of International Business Machines Corporation in Armonk, N.Y., running the Advanced Interactive Executive (AIX) operating system or LINUX operating system.

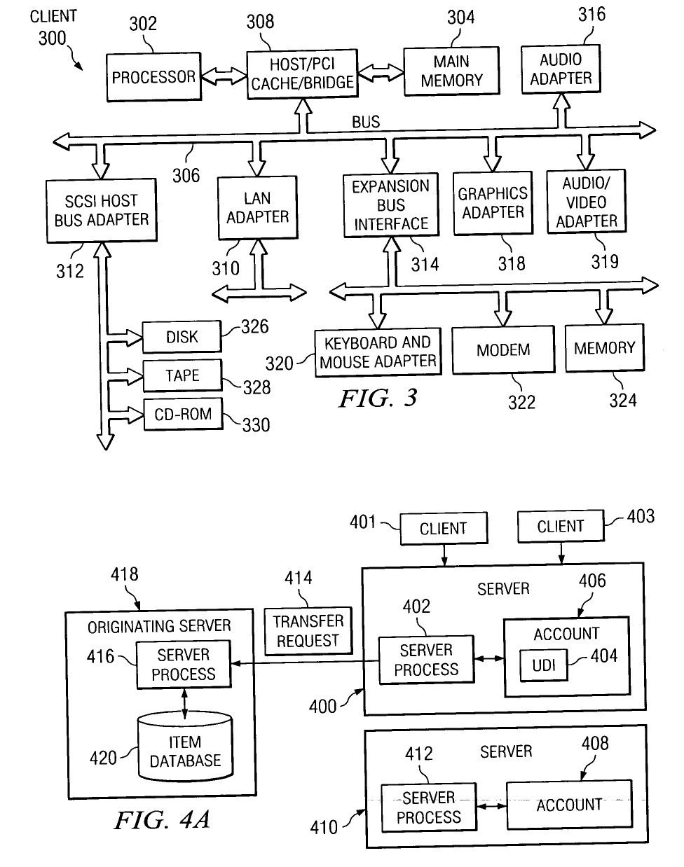

With reference now to FIG. 3, a block diagram illustrating a data processing system is depicted in which the present invention may be implemented. Data processing system 300 is an example of a client computer. Data processing system 300 employs a peripheral component interconnect (PCI) local bus architecture. Although the depicted example employs a PCI bus, other bus architectures such as Accelerated Graphics Port (AGP) and Industry Standard Architecture (ISA) may be used. Processor 302 and main memory 304 are connected to PCI local bus 306 through PCI bridge 308. PCI bridge 308 also may include an integrated memory controller and cache memory for processor 302. Additional connections to PCI local bus 306 may be made through direct component interconnection or through add-in boards. In the depicted example, local area network (LAN) adapter 310, small computer system interface (SCSI) host bus adapter 312, and expansion bus interface 314 are connected to PCI local bus 306 by direct component connection. In contrast, audio adapter 316, graphics adapter 318, and audio/video adapter 319 are connected to PCI local bus 306 by add-in boards inserted into expansion slots. Expansion bus interface 314 provides a connection for a keyboard and mouse adapter 320, modem 322, and additional memory 324. SCSI host bus adapter 312 provides a connection for hard disk drive 326, tape drive 328, and CD-ROM drive 330. Typical PCI local bus implementations will support three or four PCI expansion slots or add-in connectors.

An operating system runs on processor 302 and is used to coordinate and provide control of various components within data processing system 300 in FIG. 3. The operating system may be a commercially available operating system, such as Windows XP, which is available from Microsoft Corporation. An object oriented programming system such as Java may run in conjunction with the operating system and provide calls to the operating system from Java programs or applications executing on data processing system 300. “Java” is a trademark of Sun Microsystems, Inc. Instructions for the operating system, the object-oriented operating system, and applications or programs are located on storage devices, such as hard disk drive 326, and may be loaded into main memory 304 for execution by processor 302.

Those of ordinary skill in the art will appreciate that the hardware in FIG. 3 may vary depending on the implementation. Other internal hardware or peripheral devices, such as flash read-only memory (ROM), equivalent non-volatile memory, or optical disk drives and the like, may be used in addition to or in place of the hardware depicted in FIG. 3. Also, the processes of the present invention may be applied to a multiprocessor data processing system.

As another example, data processing system 300 may be a stand-alone system configured to be bootable without relying on some type of network communication interfaces As a further example, data processing system 300 may be a personal digital assistant (PDA) device, which is configured with ROM and/or flash ROM in order to provide non-volatile memory for storing operating system files and/or user-generated data.

The depicted example in FIG. 3 and above-described examples are not meant to imply architectural limitations. For example, data processing system 300 also may be a notebook computer or hand held computer in addition to taking the form of a PDA. Data processing system 300 also may be a kiosk or a Web appliance. The present invention provides an improved method, apparatus, and computer instructions for trading digital property. Digital property is an item that exists in electronic form. Many items that exist in the world have analogs in the cyber world. The mechanism of the present invention is directed towards unique digital items that exist on a network data processing system, such as the Internet. The mechanism of the present invention verifies ownership and authenticity of unique digital items on a server. These unique digital items may take many forms, for example, in a gaming environment an electronic trading card, token, currency, character, ring, castle, or armor. Fraud is prevented by using an originating server to facilitate the transfer of a unique digital item from one server to another server. This originating server tracks unique digital items. In other words, the location and ownership of the unique digital item is stored in a data structure, such as a database on the originating server.

If a unique digital item is transferred from a source account on one server to a target account on another server, this transfer is facilitated by the originating server. The originating server receives the request to transfer the unique digital item from the source account to the target account. This request is also referred to as a transfer request. In the illustrative example, the request includes the unique digital item as well as an identification of the target account. The originating server verifies that this item is authentic. For example, a check may be made to see as to whether the current location and owner of the item corresponds to the location and owner saved in a database of items maintained by the originating server.

If the unique digital item is determined to be authentic, the originating server sends an incoming item request to the server on which the target account is located. This request includes the unique digital item and an identification of the target account. If this server accepts the request to transfer the unique digital item, the originating server returns an acknowledgment to the server on which the unique digital item originated. At this point, the unique digital item is deleted from the source account. Additionally, the database of items is updated to reflect the change and location and possibly a change in ownership.

In this manner, the present invention provides a mechanism for secure transfer of unique digital property between different realms in which these realms may be incompatible or do not have a mutual trust mechanism. A realm may be, for example, an environment in which the unique digital property is used or originates. Two realms may exist on the same server or on different server computers.

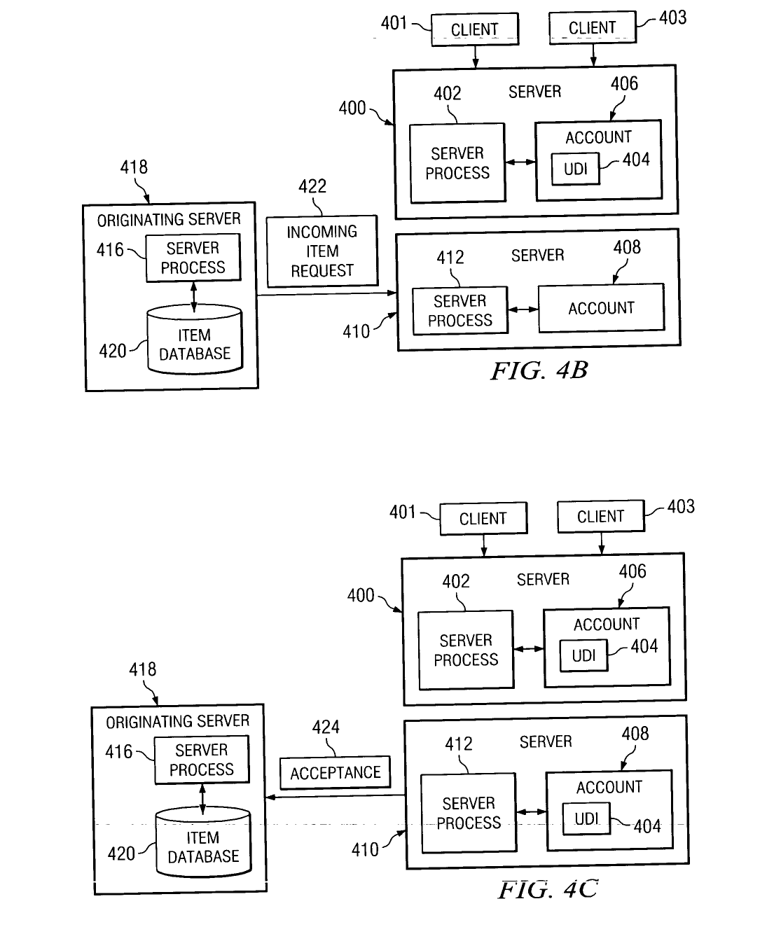

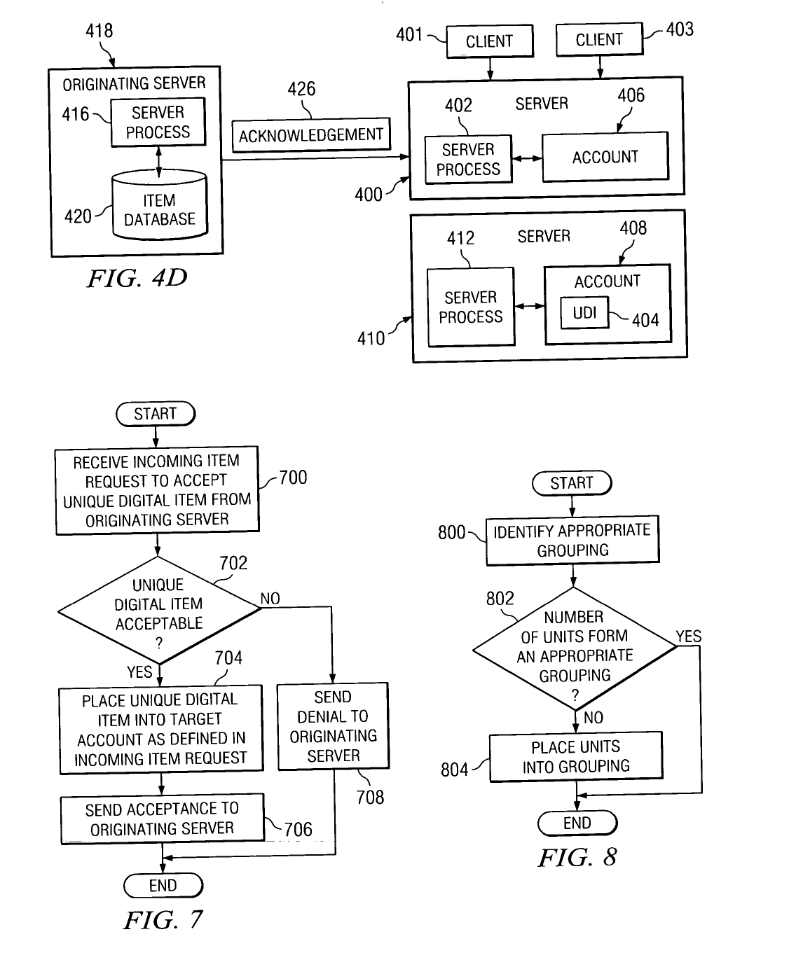

Turning next to FIGS. 4A-4D, diagrams illustrating components used in transferring unique digital items are depicted in accordance with a preferred embodiment of the present invention. In this example, server 400 in FIG. 4A includes server process 402, which is used to process requests from clients. These clients may be servers or users in these examples. Server 400 may be implemented using a data processing system, such as data processing system 200 in FIG. 2. Server 400 is a storage server. A storage server is a server on which a unique digital item is located. This storage server may be, for example, a game server or any server on which a unique digital item can be held.

In these examples, clients may be, for example, client 402 and client 403. These clients may be implemented, using a data processing system, such as data processing system 300 in FIG. 3. In this example, digital property is owned by different users. Users at these clients may agree to exchange digital property.

In these examples, the digital properties are unique digital items. Unique digital item (UDI) 404 is associated with the user in an account, such as account 406. An account in which a unique digital item is held is also referred to as a storage account.

In this example, a user at client 401 generates a request to transfer unique digital item 404 from account 406, in server 400 to a target account, such as account 408 in server 410. Account 406 is the source account and server 400 is the source server, while server 410 is the target server and account 408 is the target account. Server 410 is a storage server similar to server 400. Server 410 also includes server process 412, which is employed to handle requests from clients.

The request by the user at client 401 is not handled directly by server 400 and server 410. Instead, transfer request 414 is sent by server process 402 to server process 416 and originating server 418. Transfer request 414 includes a copy of unique digital item 404, an identification of the current owner, and identification of the target account. originating server 418 tracks unique digital items. This tracking includes identifying the location of the unique digital item, such as the server on which the unique digital item is located. Additionally, the owner of the unique digital item also is identified and stored by originating server 418. This tracking information is stored in item database 420 in the illustrative examples.

In response to receiving transfer request 414, server process 416 first determines whether the request is valid. As part of this process, server process 416 looks up unique digital item 404 in item database 420 to obtain ownership and location information about unique digital item 404. This information is compared with the ownership information from the request and with the current location of unique digital item 404 as identified by transfer request 414.

If the information received in transfer request 414 is valid, then server process 416 generates incoming item requests 422. This request includes a copy of unique digital item 404, an identification of the target account, an identification of originating server 418, and a universal resource locator needed to reach originating server 418. Incoming item request 422 is sent to server 410 in FIG. 4B.

In response to receiving this request, server process 412 determines whether to accept the unique digital item. In some cases, the unique digital item may be one that cannot be handled by server 410. Alternatively, server 410 may have a limit on unique digital items of this type and refuse to accept the request because the limit has been met on server 410. In this example, server process 412 decides to accept the unique digital item and places unique digital item 44 into account 408. At this point, unique digital item 404 also exists in account 406. To ensure that this digital item remains unique across the different domains, server process 412 returns acceptance 424 to server process 416 in originating server 418.

In response to receiving this acceptance server process 416 in originating server 418 updates information in item database 420. This update includes identifying the new location in unique digital item 404 in server 410. Also, if account 408 is owned by a different owner than account 406 the change in ownership also is reflected in item database 420.

Also in response to receiving acceptance 424 from 404 from server 410, originating server 418 sends acknowledgment 426 to server process 402 in server 400 in FIG. 4D. In response to receiving acknowledgement 406, server process 402 deletes unique digital item 404 from account 406. At this point, unique digital item 404 only exists in account 408. A similar process is performed if two unique digital items are traded between two users. In this case, the same process illustrated in FIGS. 4A-4D is used for the two unique digital items.

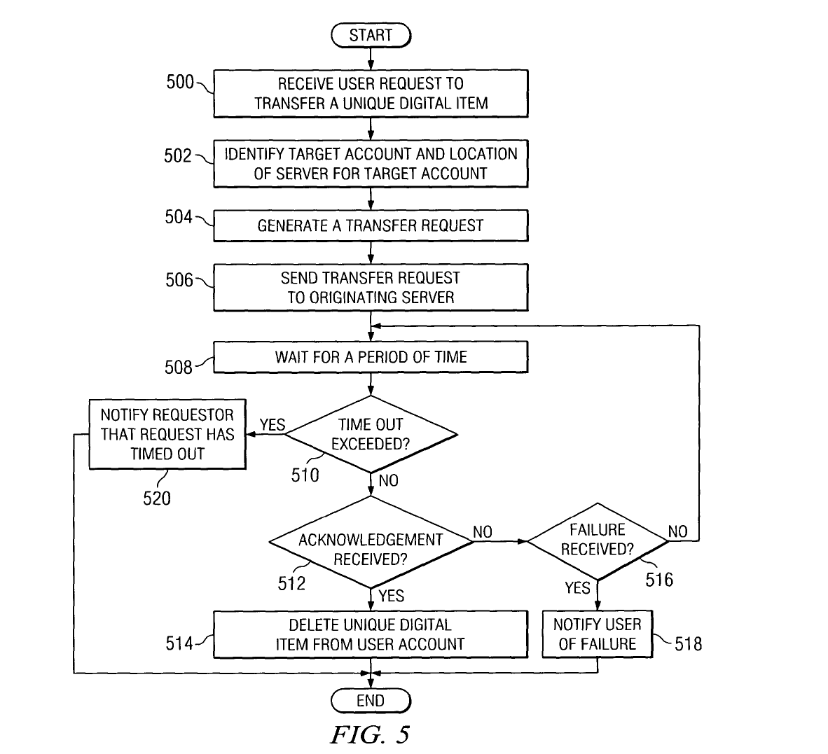

In this manner, the mechanism of the present invention provides a secure process for its changing digital items. Through the use of an originating server, the authenticity of a unique digital item may be verified. Further, this originating server allows for maintaining only a single instance of a unique digital item. Turning now to FIG. 5, a flowchart of a process for transferring a unique digital item is depicted in accordance with a preferred embodiment of the present invention. The process illustrated in FIG. 7 may be implemented in a server process, such as server process 402 in FIGS. 4A-4D.

The process begins by receiving a user request to transfer a unique digital item (step 500). This request may be received from a user through a client, such as client 402 in FIGS. 4A-4D. A target account and location of the server for the target account is identified (step 502). A transfer request is then generated (step 504). This transfer request is sent to the originating server (step 506). The process then waits for a period of time (step 508).

Next, after the period of time has past, a determination is made as to whether a timeout has been exceeded (step 510). This timeout period is set as a period of time after which an assumption is made that the originating server has not responded within a reasonable amount of time. If the timeout has not been exceeded, a determination is made as to whether an acknowledgment has been received from the originating server (step 512). If an acknowledgment has been received, the unique digital item is deleted from the user account on the server (step 514) with the process terminating thereafter.

With reference again to (step 512), if an acknowledgment has not been received from the originating server, a determination is made as to whether a failure has been received (step 516). If a failure is received, a user is notified of the failure (step 518) with the process terminating thereafter. Otherwise, the process returns to (step 508) as described above.

With reference again with (step 510), if timeout has been exceeded the requester is notified that the request has timed out (step 520). The process terminates thereafter.

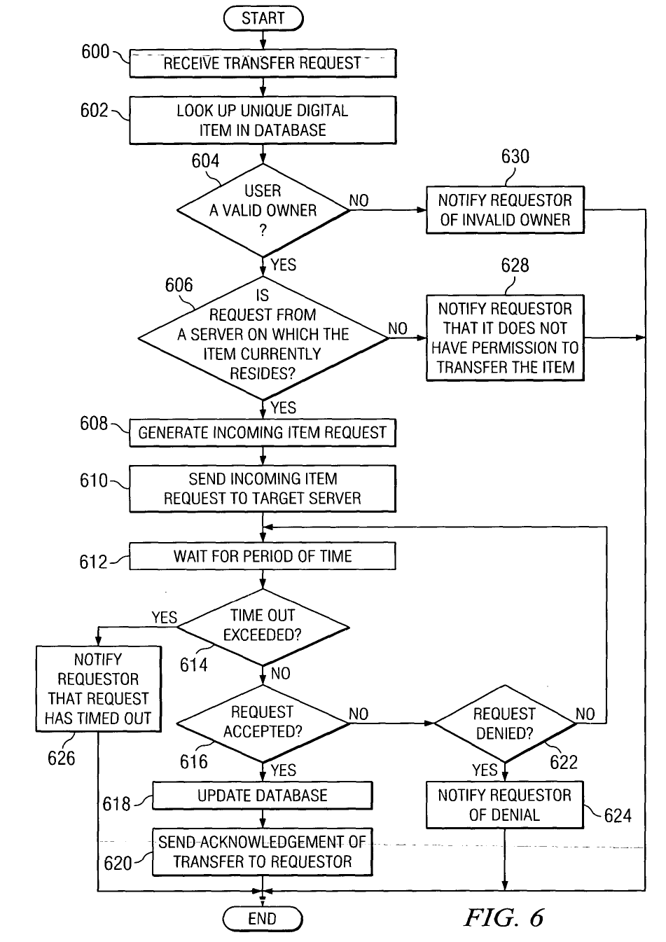

Turning now to FIG. 6, a flowchart of a process for managing a transfer of a unique digital item is depicted in accordance with a preferred embodiment of the present invention. The process illustrated in FIG. 5 may be implemented in a server process in an originating server, such as server process 416 in FIGS. 4A-4D.

The process begins by receiving a transfer request from a server on which a unique digital item is located (step 600). This request includes the unique digital item, an identification of the owner, and an identification of the target account. This identification of the target account also includes the location of the server on which the target account is found. In response to receiving the request, a lookup of the unique digital item is made in a database (step 602).

A determination is made as to whether the owner identified in the request is a valid owner (step 604). If the owner is a valid owner, a determination is made as to whether the request is from a server on which the item currently resides (step 606). Step 606 is employed to insure that a fake or bogus transfer request is not created by an unethical source server to move a unique digital item without the owner's knowledge or permission.

If the request is from a server on which the item currently resides, an incoming item request is generated (step 608). This request is sent to the target server (step 610).

Next, the process waits for a period of time (step 612). After the period of time has passed, a determination is made as to whether a timeout has been exceeded (step 614). If the timeout has not been exceeded, a determination is then made as to if the request has been accepted by the target server (step 616). If the request has been accepted, the database is updated (step 618). This update includes the new location of the new digital item as well as any change in ownership. An acknowledgement of the transfer is sent to the requester (step 620) with the process terminating thereafter.

Turning back to (step 616), if the request is not accepted, a determination is made as to whether the request has been denied (step 622). If the request has not been denied, the process returns to (step 612). Otherwise, the requester is notified of the denial (step 624) with the process terminating thereafter. Turning back to (step 614), if the timeout has been exceeded the requester is notified that the request has timed out (step 626). The process terminates thereafter.

With reference back to (step 606), if the request is not from a server on which the item currently resides, the requester is notified that it does not have permission to transfer the item (step 628). The process terminates thereafter.

With reference again to (step 604), if the user is not a valid owner, the requester is notified of the invalid owner (step 630) with the process terminating thereafter. In this manner, the originating server manages transfers of unique digital items between different domains.

With reference next to FIG. 7, a flowchart of a process for managing a transfer of a unique digital item is depicted in accordance with a preferred embodiment of the present invention. The process illustrated in FIG. 7 may be implemented in a server process in a target server, such as server process 412 in FIGS. 4A-4D.

The process begins by receiving an incoming item request to accept a unique digital item from an originating server (step 700). A determination is then made as to whether the unique digital item is acceptable to the server (step 702). In some cases, a limit may be present as to how many unique digital items of a certain type may be located on a server or a domain. If this limit is exceeded the item is not acceptable. Also, in some cases the item may not be handled by the server or domain.

If the unique digital item is acceptable, this item is placed into a target account as defined in the incoming item request (step 704). Thereafter, an acceptance of the request is sent to the originating server (step 706) with the process terminating thereafter.

With reference again to step 702, if the unique digital item is not acceptable on the server, a denial is sent to the originating server (step 708) with the process terminating thereafter.

Turning to FIG. 8, a flowchart of a process for grouping items is depicted in accordance with a preferred embodiment of the present invention. The process illustrated in FIG. 8, may be implemented on a server process in a source server, such as server process 402 in FIGS. 4A-4D.

The process begins by identifying an appropriate grouping or lot for the units that are to be transferred (step 800). In some cases, unique digital items may take the form of gold pieces or event tickets. A user may trade or move these items in various numbers. For example, if a user has 557 gold pieces, a transfer of this gold may be handled most efficiently by handling lots that do not contain more than 500 gold pieces. In this case, the transfer is for a lot of 500 gold pieces and a lot of 57 gold pieces.

Next, a determination is made as to whether the number of units form an appropriate grouping (step 802). If the number of units do not form an appropriate grouping, the units are placed into the appropriate grouping (step 804) with the process terminating thereafter. With reference again to step 802, if the number of units form an appropriate grouping the process also terminates.

Thus, the present invention provides a method, apparatus, and computer instructions for securely transferring unique digital items. The mechanism of the present invention employs an originating server to authenticate unique digital items as well as transfer of these items. With this mechanism, an escrow system is unnecessary because the originating server handles placing the unique digital item in the target account as well as deleting the unique digital item from the source account.

It is important to note that while the present invention has been described in the context of a fully functioning data processing system, those of ordinary skill in the art will appreciate that the processes of the present invention are capable of being distributed in the form of a computer readable medium of instructions and a variety of forms and that the present invention applies equally regardless of the particular type of signal bearing media actually used to carry out the distribution. Examples of computer readable media include recordable-type media, such as a floppy disk, a hard disk drive, a RAM, CD-ROMs, DVD-ROMs, and transmission-type media, such as digital and analog communication links, wired or wireless communication links using transmission forms, such as, for example, radio frequency and light wave transmissions. The computer readable media may take the form of coded formats that are decoded for actual use in a particular data processing system.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

1. A method in a network data processing system for transferring a unique digital item, the method comprising:
receiving a request to transfer a unique digital item from a source account on a source data processing system to a target account on a target data processing system, wherein the transfer request includes the unique digital item and an identification of the target account;
determining whether the request is valid in response to receiving the request;
responsive to the request being valid, attempting a transfer of the unique digital item to the target account in the second data processing system; and
responsive to a successful transfer of the unique digital item to the target account, deleting the unique digital item from the source account in the source data processing system.

2. The method of claim 1, wherein the transfer of the unique digital item is from the originating data processing system to the target data processing system.

3. The method of claim 1, wherein the attempting step includes:
sending an incoming item request to the target server, wherein the incoming item request includes the unique digital item and the identification of the target account;
responsive to receiving an acceptance of the incoming item request, updating a data structure to reflect the transfer of the unique digital item.

4. The method of claim 1, wherein the deleting step comprises:
sending an acknowledgment of the request to the source data processing system, wherein the acknowledgment causes the source data processing system to delete the unique digital item from the source account.

5. The method of claim 1, wherein the target account is owned by a same owner of the source account.

6. The method of claim 1, wherein the source account is owned by a first user and the target account is owned by a second user.

7. The method of claim 1, wherein the unique digital item is one of a set of event tickets, a plurality of gold pieces, character, castle, ring, armor, or weapon.

8. A method in data processing system for transferring a unique digital item, the method comprising:
responsive to receiving a user request from a user to transfer the unique digital item from a first account on a the data processing system to a second account on a remote data processing system, sending a transfer request; and
deleting the unique digital item from the first account on the data processing system in response to receiving an acknowledgment of a transfer of the unique digital item to the second account on the remote data processing system.

9. The method of claim 8, wherein the transfer request is sent to an originating server, wherein the originating server tracks location and ownership of unique digital items on different data processing systems.

10. The method of claim 8, wherein the unique digital item is one of a set of event tickets, a plurality of gold pieces, character, castle, ring, armor, or weapon.

11. A data processing system in a network data processing system for transferring a unique digital item, the data processing system comprising:
receiving means for receiving a request to transfer a unique digital item from a source account on a source data processing system to a target account on a target data processing system, wherein the transfer request includes the unique digital item and an identification of the target account;
determining means for determining whether the request is valid in response to receiving the request;
attempting means responsive to the request being valid, for attempting a transfer of the unique digital item to the target account in the second data processing system; and
deleting means responsive to a successful transfer of the unique digital item to the target account, for deleting the unique digital item from the source account in the source data processing system.

12. The data processing system of claim 11, wherein the transfer of the unique digital item is from the originating data processing system to the target data processing system.

13. The data processing system of claim 11, wherein the attempting means includes:
sending means for sending an incoming item request to the target server, wherein the incoming item request includes the unique digital item and the identification of the target account;
updating means responsive to receiving an acceptance of the incoming item request, for updating a data structure to reflect the transfer of the unique digital item.

14. The data processing system of claim 11, wherein the deleting means comprises:
sending means for sending an acknowledgment of the request to the source data processing system, wherein the acknowledgment causes the source data processing system to delete the unique digital item from the source account.

15. The data processing system of claim 11, wherein the target account is owned by a same owner of the source account.

16. The data processing system of claim 11, wherein the source account is owned by a first user and the target account is owned by a second user.

17. The data processing system of claim 11, wherein the unique digital item is one of a set of event tickets, a plurality of gold pieces, character, castle, ring, armor, or weapon.

18. A data processing system for transferring a unique digital item, the data processing system comprising:
sending means, responsive to receiving a user request from a user to transfer the unique digital item from a first account on a the data processing system to a second account on a remote data processing system, for sending a transfer request; and
deleting means for deleting the unique digital item from the first account on the data processing system in response to receiving an acknowledgment of a transfer of the unique digital item to the second account on the remote data processing system.

19. The data processing system of claim 18, wherein the transfer request is sent to an originating server, wherein the originating server tracks location and ownership of unique digital items on different data processing systems.

20. The data processing system of claim 18, wherein the unique digital item is one of a set of event tickets, a plurality of gold pieces, character, castle, ring, armor, or weapon.

21. A computer program product in a computer readable medium for transferring a unique digital item, the computer program product comprising:
first instructions for receiving a request to transfer a unique digital item from a source account on a source data processing system to a target account on a target data processing system, wherein the transfer request includes the unique digital item and an identification of the target account;
second instructions for determining whether the request is valid in response to receiving the request;
third instructions responsive to the request being valid, for attempting a transfer of the unique digital item to the target account in the second data processing system; and
fourth instructions responsive to a successful transfer of the unique digital item to the target account, for deleting the unique digital item from the source account in the source data processing system.

22. The computer program product of claim 21, wherein the transfer of the unique digital item is from the originating data processing system to the target computer program product.

23. The computer program product of claim 21, wherein the third instructions includes:
first sub-instructions for sending an incoming item request to the target server, wherein the incoming item request includes the unique digital item and the identification of the target account;
second sub-instructions responsive to receiving an acceptance of the incoming item request, for updating a data structure to reflect the transfer of the unique digital item.

24. The computer program product of claim 21, wherein the fourth instructions comprises:
sub-instructions for sending an acknowledgment of the request to the source data processing system, wherein the acknowledgment causes the source data processing system to delete the unique digital item from the source account.

25. The computer program product of claim 21, wherein the target account is owned by a same owner of the source account.

26. The computer program product of claim 21, wherein the source account is owned by a first user and the target account is owned by a second user.

27. The computer program product of claim 21, wherein the unique digital item is one of a set of event tickets, a plurality of gold pieces, character, castle, ring, armor, or weapon.

28. A computer program product in a computer readable medium for transferring a unique digital item, the computer program product comprising:
first instructions responsive to receiving a user request from a user to transfer the unique digital item from a first account on a the data processing system to a second account on a remote data processing system, for sending a transfer request; and
second instructions for deleting the unique digital item from the first account on the data processing system in response to receiving an acknowledgment of a transfer of the unique digital item to the second account on the remote data processing system.

29. The computer program product of claim 28, wherein the transfer request is sent to an originating server, wherein the originating server tracks location and ownership of unique digital items on different data processing systems.

30. The computer program product of claim 28, wherein the unique digital item is one of a set of event tickets, a plurality of gold pieces, character, castle, ring, armor, or weapon.

31. A data processing system comprising:
a bus system;
a memory connected to the bus system, wherein the memory includes a set of instructions; and
a processing unit connected to the bus system, wherein the processing unit executes the set of instructions to receive a request to transfer a unique digital item from a source account on a source data processing system to a target account on a target data processing system, wherein the transfer request includes the unique digital item and an identification of the target account; determine whether the request is valid in response to receiving the request; attempt a transfer of the unique digital item to the target account in the second data processing system and respond to the request being valid; and delete the unique digital item from the source account in the source data processing system and respond to a successful transfer of the unique digital item to the target account.

32. A data processing system comprising:
a bus system;
a memory connected to the bus system, wherein the memory includes a set of instructions; and
a processing unit connected to the bus system, wherein the processing unit executes the set of instructions, to send a transfer request responsive to receive a user request from a user to transfer the unique digital item from a first account on a the data processing system to a second account on a remote data processing system; and delete the unique digital item from the first account on the data processing system in response to receiving an acknowledgment of a transfer of the unique digital item to the second account on the remote data processing system.
